(19) United States
(12) Patent Application Publication
(10) Pub. No.: US 2011/0033123 A1
(43) Pub. Date: Feb. 10, 2011

(54) Electric Greeting Card

(75) Inventor: Deaji Lou, Guangdong (CN)

Correspondence Address: DONGGUAN TAIYO OPTRONICS CO., LTD, BAISHIGANG MANAGEMENT DISTRICT, CHANGPING TOWN DONGGUAN, GUANGDONG, 523559, omitted

(73) Assignee: DONGGUAN TAIYO OPTRONICS CO., LTD, GUANGDONG (CN)

(21) Appl. No.: 12/937,997

(22) PCT Filed: Mar. 31, 2009
(86) PCT No.: PCT/CN2009/071097

§ 371 Date: Oct. 15, 2010

(30) Foreign Application Priority Data
Dec. 18, 2008 (CN) 200810220138.7

(51) Int. Cl. G06K 9/36

(52) U.S. Cl. 382/232

(57) ABSTRACT

The present invention discloses an electronic greeting card, comprising a back cover and a front cover folded onto the back cover, wherein, the back cover has an IC block, a power supply module a pull switch connected to the IC block respectively, and a LCD connected to the IC block; the IC block comprises a memory module that stores digital images and a main control chip module that decodes the images and transmits the decoded data to the LCD for display; the main control chip module comprises: a decoding module that decodes the digital images, an image processing module that processes the decoded image data, and an encoding module that encodes the processed image data so as to store the image data in the memory module; the IC block is powered by an Li-Mn cell. The greeting card can display the digital images stored in the memory module on the LCD, to meet the consumer's demand for transmitting dynamic digital images.

### BACKGROUND OF THE INVENTION

The present invention relates to a greeting card, in particular to a folded electronic greeting card that carries multimedia information.

In our daily life, people tend to send congratulations and greetings to express blessings and wishes on festivals, birthdays, and commemorable days. Greeting cards are a favorable way to attain that purpose. Pattern, text, shape, voice, music, and image, etc. are elements of greeting cards to express emotions. At present, popular greeting cards available in the market include single-sheet folded greeting cards, three-dimensional folded greeting cards, and electronic music greeting cards. Single-sheet folded greeting cards or three-dimensional folded greeting cards can only bear and convey pattern, text, and shape information; electronic music greeting cards can only bear and convey voice and music information. As the form of emotional exchange is improved to a new level of dynamic digital image representation, the existing electronic greeting cards can't meet the demand.

### BRIEF SUMMARY OF THE INVENTION

The object of the present invention is to provide an electronic greeting card that can convey dynamic digital images.

The present invention solves the technical problem with the following technical scheme: an electronic greeting card, comprising a back cover and a front cover folded onto the back cover, wherein, the back cover has an IC block, a buzzer and a pull switch connected to the IC block respectively, and a LCD connected to the IC block; the IC block comprises a memory module that stores digital images and a main control chip module that decodes the images and transmits the decoded image data to the LCD for display.

The main control chip module comprises: a decoding module that decodes the digital images, an image processing module that processes the decoded image data, and an encoding module that encodes the processed image data so as to store the image data in the memory module. The IC block is powered by a Li-Mn cell.

The beneficial efficacies of the present invention lie in: with the LCD, memory module and main control chip module connected to the LCD on the back cover, the digital images stored in the memory module can be displayed on the LCD, to meet the demand of the consumer for transmitting dynamic digital images.

### BRIEF DESCRIPTION OF THE DRAWINGS

Hereunder the present invention will be further detailed in the embodiments, with reference to the accompanying drawings.

FIG. 1 is a structural diagram of the present invention;

FIG. 2 is a structural diagram of the IC block in the present invention.

### DETAILED DESCRIPTION OF THE INVENTION

Hereunder the present invention will be further detailed, with reference to the accompanying drawings.

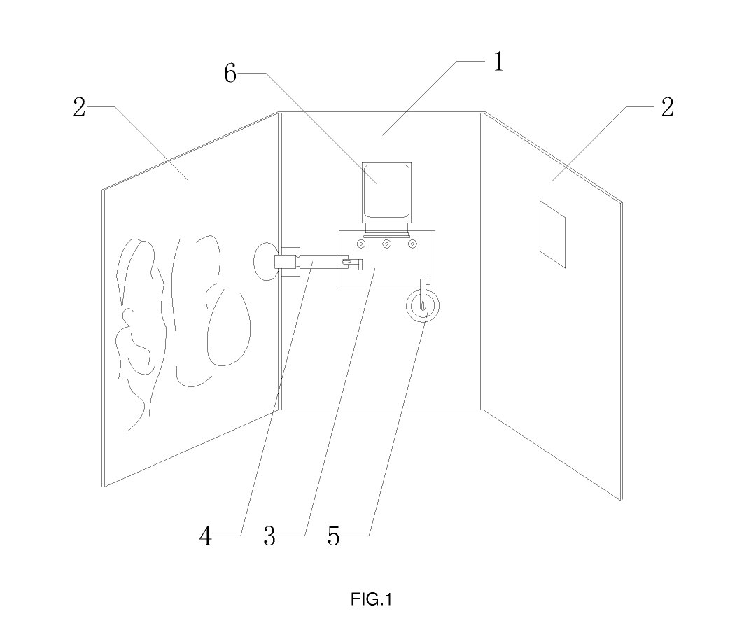

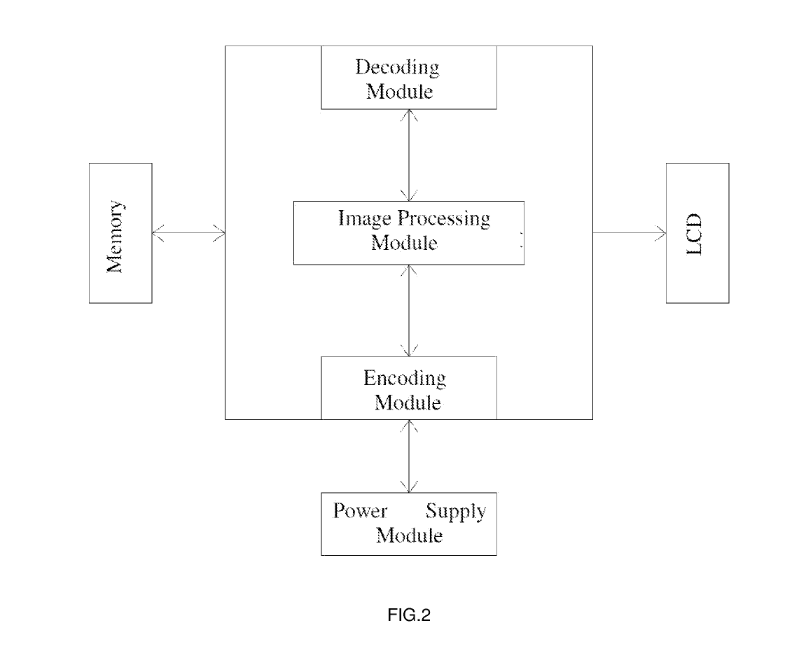

As shown in FIG. 1 and FIG. 2, the present invention provides an electronic greeting card, which is in a tri-folded form, and comprises a back cover 1 and a front cover 2 folded onto the back cover 1, wherein, the back cover 1 has an IC block 3, a buzzer 5 and a pull switch 4 connected to the IC block 3 respectively, and a LCD 6 connected to the IC block 3; the IC block 3 comprises a memory module that stores digital images and a main control chip module that decodes the digital images and transmits the decoded image data to the LCD 6. The main control chip module comprises: a decoding module that decodes the digital images, an image processing module that processes the decoded image data, and an encoding module that encodes the processed image data so as to store the image data in the memory module. The IC block 3 is powered by a Li-Mn cell. With the LCD, memory module and main control chip module connected to the LCD on the back cover, the digital images stored in the memory module can be displayed on the LCD; when the greeting card is spread to a predefined position, the pull switch 4 will switch on the power supply, and the digital images stored in the memory card will be displayed on the LCD; thus, the consumer's demand for transmitting dynamic digital images is met fully.

While the principle, efficacies, and some application embodiments of the present invention are described and illustrated in above embodiments, the present invention is not limited to these. Those skilled in the art can make variations and modifications without departing from the spirit of the present invention; however, such variations and modifications shall be deemed as falling into the protected domain of the present invention.

What is claimed is:

1. An electronic greeting card, comprising a back cover (1) and a front cover (2) folded onto the back cover (1), wherein, the back cover (1) has an IC block (3), a buzzer (5) and a pull switch (4) connected to the IC block (3) respectively; wherein, the back cover (1) further has a LCD (6) connected to the IC block 3; the IC block (3) comprises a memory module that stores digital images and a main control chip module that decodes the digital images and transmits the decoded image data to the LCD (6).

2. The electronic greeting card according to claim 1, wherein, the main control chip module comprises: a decoding module that decodes the digital images, an image processing module that processes the decoded image data, and an encoding module that encodes the processed image data so as to store the image data in the memory module.

3. The electronic greeting card according to claim 1 or 2, wherein, the IC block (3) is powered by a Li-Mn cell.
